(19) United States
(12) Patent Application Publication
(10) Pub. No.: US 2002/0117899 A1
(43) Pub. Date: Aug. 29, 2002

(54) Telecommunications power distribution systems, telecommunications power distribution circuits and methods of supplying power to at least one telecommunications device

(76) Inventors: Jeff Seefried, Veradale, WA (US); David Babcock, Spokane, WA (US)

Correspondence Address: WELLS ST. JOHN P.S., 601 W. FIRST, SUITE 1300, SPOKANE, WA, 99201-3828, US

(21) Appl. No.: 09/794,544

(22) Filed: Feb. 26, 2001

(51) Int. Cl. H02J 9/00

(52) U.S. Cl. 307/64

(57) ABSTRACT

According to a first aspect of the invention, a telecommunications power distribution system includes a main power source; a reserve power source; a telecommunications device connection adapted to supply power to at least one telecommunications device configured to perform at least one operation with respect to telecommunications; a switching device configured to selectively couple the reserve power source device with the telecommunications device connection; and a lockout circuit configured to monitor an electrical condition of at least one of the main power source and the reserve power source, and to control the switching device responsive to the monitoring. to perform at least one operation with respect to telecommunications; a switching device configured to selectively couple the reserve power source device with the telecommunications device connection; a power controller configured to selectively provide a power control signal to control the switching device to couple the reserve power source with the telecommunications device connection; and a lockout circuit configured to selectively prevent the power control signal from controlling the switching device responsive to an operational condition of the telecommunications.

### TECHNICAL FIELD

The present invention relates to telecommunications power distribution systems, telecommunications power distribution circuits and methods of supplying power to at least one telecommunications device.

### BACKGROUND OF THE INVENTION

The telecommunications industry has enjoyed expansive growth due to increased usage for voice and data applications. Accordingly, providers of telecommunications services have increased capacity to accommodate the demands for the increased usage of both voice and data applications. Telecommunications facilities typically comprise complex networks of switches, multiplexers, etc. to implement telecommunications operations. Power distribution systems for telecommunications applications have also increased in complexity. As outlined below, certain drawbacks exist with some conventional power distribution designs for telecommunications systems.

Problems may exist when powering up a conventional power distribution system, such as upon installation. In numerous applications, batteries are implemented to provide auxiliary or back-up power when a line source is down or otherwise unavailable. Contactors are utilized in some applications to provide coupling of batteries to an appropriate bus. Equipment must be powered up in a correct order in conventional arrangements to prevent in-rush current damage to the contacts of the contactors.

For example, if rectifiers are powered up before the contactor closes to bring batteries on-line, output capacitance of the rectifiers is charged by the rectifiers and no in-rush current flows through the contactor. However, if the batteries are brought on-line while the rectifiers are off, and DC output breakers therein are closed, an in-rush current will flow from the batteries through the contactor to the output capacitance of the rectifiers causing damage or destruction of the contactor contacts.

Another example wherein problems may be experienced during installation or powering up of a system is the coupling of battery leads in reversed polarity with respect to the associated bus. If the rectifiers are connected correctly to the bus and powered up, some conventional systems would allow the contactor to engage thereby connecting the batteries in reverse polarity to the rectifiers. Such may cause excessive currents to flow from the batteries to the output capacitance of the rectifiers. Such capacitance is typically polarity sensitive and acts as a short circuit to DC when the polarity is reversed. This situation also results in the conduction of excessive in-rush currents through the contactor contacts which may damage the contactor.

Another example of problems associated with installation or powering up of conventional systems is for rectifier leads to be connected in reversed polarity to an associated bus. If the batteries are connected in the proper polarity, existing conventional systems allow the contactor to engage and the batteries are coupled to the rectifiers having output capacitance provided in reversed polarity. This causes excessive currents to flow from the batteries to the output capacitance of the rectifiers which may damage the contactor.

Yet another problem associated with some conventional configurations is experienced when a load coupled with the bus is inadvertently shorted during installation. Some prior art systems permit the batteries to be brought on-line before the rectifiers and as soon as the contactors are closed, excessive short circuit currents may be generated resulting in damage to the contacts of the contactor.

Thus, there exists a need to provide improved systems and methodologies for distributing power to telecommunications devices and components.

### BRIEF DESCRIPTION OF THE DRAWINGS

Preferred embodiments of the invention are described below with reference to the following accompanying drawings.

FIG. 1 is a high-level functional block diagram of an exemplary telecommunications system.

FIG. 2 is a functional block diagram depicting components of an exemplary power distribution system of the telecommunications system.

FIG. 3 is functional block diagram of a main power source of the telecommunications power distribution system.

FIG. 4 is a schematic representation of an exemplary lockout circuit of the telecommunications power distribution system.

FIG. 5 is a schematic representation of circuit components of an exemplary power controller of the telecommunications power distribution system.

FIG. 6 is a schematic representation of an exemplary indicator of the telecommunications power distribution system.

### DETAILED DESCRIPTION OF THE PREFERRED EMBODIMENTS

This disclosure of the invention is submitted in furtherance of the constitutional purposes of the U.S. Patent Laws “to promote the progress of science and useful arts” (Article 1, Section 8).

According to a first aspect of the invention, a telecommunications power distribution system comprises: a main power source; a reserve power source; a telecommunications device connection adapted to supply power to at least one telecommunications device configured to perform at least one operation with respect to telecommunications; a switching device configured to selectively couple the reserve power source device with the telecommunications device connection; and a lockout circuit configured to monitor an electrical condition of at least one of the main power source and the reserve power source, and to control the switching device responsive to the monitoring.

Another aspect of the invention provides a telecommunications power distribution system comprising: a reserve power source; a telecommunications device connection adapted to supply power to at least one telecommunications device configured to perform at least one operation with respect to telecommunications; a switching device configured to selectively couple the reserve power source device with the telecommunications device connection; a power controller configured to selectively provide a power control signal to control the switching device to couple the reserve power source with the telecommunications device connection; and a lockout circuit configured to selectively prevent the power control signal from controlling the switching device responsive to an operational condition of the telecommunications power distribution system.

According to another aspect, a telecommunications power distribution circuit comprises: a first coupling adapted to couple with a main power source; a second coupling adapted to couple with a reserve power source; a third coupling adapted to communicate a control signal to control selective coupling of the reserve power source device with a telecommunications device connection configured to supply power to at least one telecommunications device configured to perform at least one operation with respect to telecommunications; and a lockout circuit configured to receive signals from at least one of the first coupling and the second coupling to monitor an electrical condition of at least one of the main power source and the reserve power source, the lockout circuit being further configured to provide the control signal to the third coupling responsive to the monitoring.

Yet another aspect provides a method of supplying power to at least one telecommunications device configured to perform at least one operation with respect to telecommunications, the method comprising: monitoring at least one electrical condition of a main power source and a reserve power source; electrically coupling the reserve power source and a telecommunications device connection adapted to supply power to at least one telecommunications device; and controlling the coupling responsive to the monitoring of the at least one electrical condition of the main power source and the reserve power source to selectively control application of power from the reserve power source to the telecommunications device coupled with the telecommunications device connection.

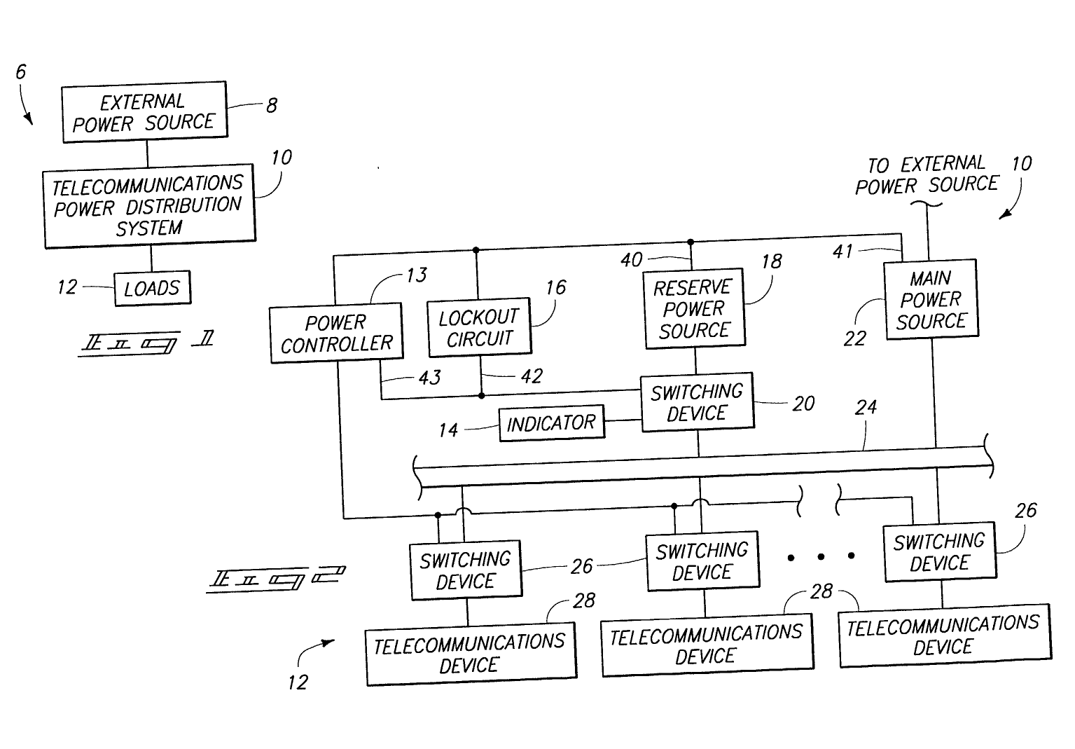

Referring to FIG. 1, an exemplary telecommunications system 6 comprises a telecommunications power distribution system 10 coupled with a external source 8 and one or more load 12. Telecommunications system 6 is configured to implement telecommunications operations, such as call switching within a central office, for example. Telecommunications system 6 is configured to provide other telecommunications operations according to other aspects of the invention.

Telecommunications power distribution system 10 operates to provide power from external source 8 to loads 12. External source 8 comprises a utility power line providing alternating current (AC) power in the described embodiment. Other sources are possible for originating power for use in loads 12.

Telecommunications power distribution system 10 includes one or more component configured to deliver power from external source 8 to loads 12. For example, telecommunications power distribution system 10 can include a distribution panel (not shown) coupled with plural distribution modules (not shown). The distribution panel may be located proximate access to external source 8 while distribution modules may be remotely located from the distribution panel to provide power to loads 12 spaced some distance from the panel. In addition to power distribution functionality, system 10 may be arranged to include safety circuitry, such as circuit breakers, and filtering circuitry to reduce the presence of noise.

Loads 12 comprise telecommunication devices operable to perform at least one operation with respect to telecommunications. Exemplary operations include implementing switching functions for subscriber lines, such as connecting subscriber lines to one another including local and long distance lines within a central office. Exemplary configurations of telecommunication devices include line switches, digital cross connects, level monitors, multiplexers, etc.

Telecommunications power distribution system 10 provides direct current (DC) power to loads 12. In exemplary arrangements, a voltage within a range of −42 to −58 Volts DC is applied to loads 12. Typical voltages applied to loads 12 within telecommunications system 6 are between −52 Volts DC and −54 Volts DC. Other arrangements are possible and telecommunications power distribution system 10 is configured to provide other voltage power to loads 12 according to the other arrangements.

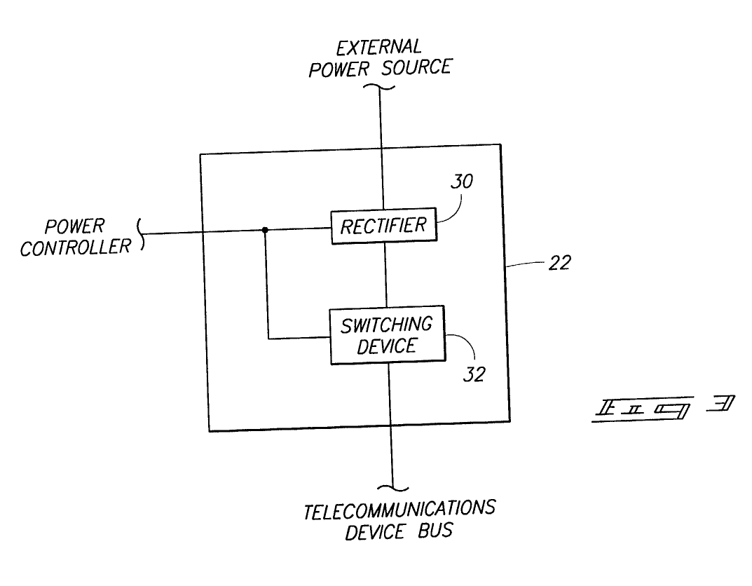

Referring to FIG. 2, an exemplary embodiment of a telecommunications power distribution system 10 is depicted. As shown, telecommunications power distribution system 10 includes a power controller 13, indicator 14, lockout circuit 16, reserve power source 18, switching device 20, main power source 22, and a telecommunications device connection 24.

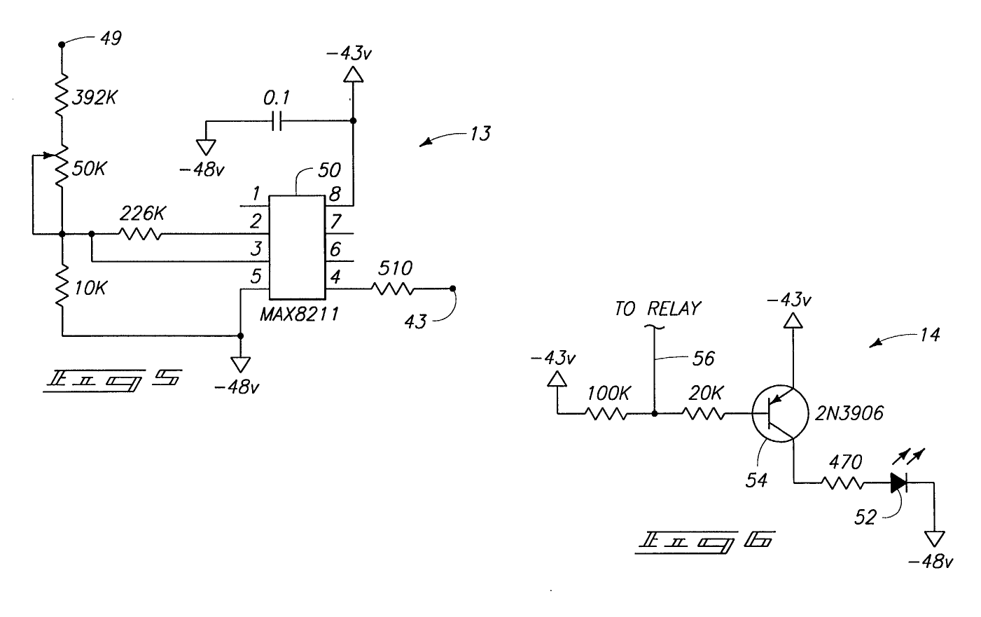

A plurality of loads 12 are shown coupled with telecommunications device connection 24. Connection 24 is configured as a bus or other suitable device for communicating electrical power. In one exemplary arrangement, individual loads 12 comprise a switching device 26 coupled with a telecommunications device 28. Switching device 26 is a circuit breaker coupled intermediate telecommunications device 28 and telecommunications device connection 24. Power controller 13 is configured to monitor individual switching devices 26 in the depicted embodiment. Details of an exemplary power controller 13 are discussed below with reference to FIG. 5. Telecommunications device connection 24 supplies the power from main power source 22 and/or reserve power source 18 to loads 12 including telecommunications devices 28.

The depicted telecommunications power distribution system 10 may be utilized within any component or arrangement configured to deliver power from source 8 to telecommunications devices of loads 12. The components depicted in FIG. 2 are implemented within a system 10 comprising a lowvoltage battery disconnect fuse/circuit breaker distribution panel in one exemplary arrangement. Other applications of the telecommunications power distribution system 10 are possible.

The depicted telecommunications power distribution system 10 includes reserve power source 18 and main power source 22 to provide power to telecommunications device connection 24 and individual devices 28 coupled therewith. During normal operations, main power source 22 receives appropriate power from external source 8. At times when the external power source 8 experiences a failed mode of operation or otherwise can not supply power to system 10, reserve power source 18 is utilized to provide reserve power for usage by telecommunications devices 28. Devices 28 may be located in remote locations and accordingly, auxiliary or reserve power sources 18 are utilized to provide uninterrupted power in the event of failure of main power source 22.

In some configurations, reserve power source 18 comprises one or more battery configured to provide reserve power for usage within telecommunications devices 28. During periods of normal operation wherein power from the external power source 8 is provided, such power may be utilized to recharge or maintain the batteries of reserve power source 18.

Referring to FIG. 3, an exemplary configuration of main power source 22 is depicted. The illustrated main power source 22 includes a rectifier 30 coupled with a switching device 32 (additional rectifiers and/or switching devices may be provided). Rectifier 30 operates to receive and rectify alternating current power from external power source 8. Switching device 32 operates as a protection device, such as a circuit breaker, to selectively isolate telecommunications device connection 24 from the external power source 8. Rectifier 30 and switching device 32 are both coupled with power controller 13 in the illustrated embodiment. Power controller 13 monitors rectifier 30 including voltage of rectifier 30.

Referring again to FIG. 2, switching device 20 is provided intermediate reserve power source 18 and telecommunications device connection 24. Switching device 20 operates to selectively couple reserve power source 18 with telecommunications device connection 24. In one arrangement, switching device 20 is implemented as a contactor controllable by power controller 13 and/or lockout circuit 16 as described in detail below. An exemplary contactor has designation SW180-685 available from Curtis/Albright.

Lockout circuit 16 comprises a telecommunications power distribution circuit configured to protect switching device 20 from excessive currents or other overage conditions which may damage switching device 20 or other components of system 10 according to aspects of the present invention. Power controller 13 asserts power control signals via a coupling 43 to control the operations of switching device 20 to selectively couple reserve power source 18 with telecommunications device connection 24. Lockout circuit 16 prevents power controller 13 from closing switching device 20 if damage to components could result.

In one example, responsive to an operator request to provide system 10 and telecommunications devices 28 on-line, power controller 13 provides a power control signal to switching device 20 to attempt to couple reserve power source 18 and telecommunications device connection 24. Lockout circuit 16 selectively permits or prevents the power control signal from controlling the switching device 20 (e.g., lockout circuit 16 locks out switching device 20 if such device may be subjected to excessive currents or other overage conditions not detected by power controller 13).

According to exemplary embodiments, lockout circuit 16 monitors an electrical condition of main power source 22 and/or reserve power source 18 and controls application of power control signals from power controller 13 to switching device 20 responsive to the monitoring. Lockout circuit 16 operates to selectively prevent power control signals from power controller 13 from controlling switching device 20 responsive to an operational condition of telecommunications power distribution system 10.

In the depicted arrangement of FIG. 2, lockout circuit 16 is coupled with reserve power source 18 and main power source 22 via respective couplings 40, 41 to monitor operations of the respective sources. Coupling 42 is operable to communicate control signals from lockout circuit 16 to control selective coupling of the reserve power source 18 and telecommunications device connection 24 using switching device 20. In effect, lockout circuit 16 prevents power control signals of power controller 13 from closing switching device 20 if overage conditions could result thereby. Accordingly, lockout circuit 16 selectively permits power control signals from power controller 13 to control switching device 20 or alternatively locks out such control signals according to aspects of the present invention.

During normal operation of the illustrated telecommunications power distribution system 10, rectifier 30 of main power source 22 is provided in an “on” condition prior to coupling reserve power source 18 with connection 24 to avoid damaging switching device 20 or other components.

According to aspects of the invention, lockout circuit 16 is configured to monitor a voltage of rectifier 30 of main power source 22 and to control switching device 20 responsive thereto. For example, lockout circuit 16 controls switching device 20 to prevent coupling of reserve power source 18 and connection 24 responsive to a voltage of rectifier 30 being below a predetermined value. In the illustrated exemplary configuration, lockout circuit 16 is configured to compare electrical conditions of reserve power source 18 and main power source 22. Lockout circuit 16 is provided in the described embodiment to prevent coupling of reserve power source 18 and connection 24 responsive to the voltage magnitude of rectifier 30 being 1.4 Volts less than reserve power source 18 (e.g. if reserve power source 18 provides −48 Volts and rectifier 30 is providing −45.8 Volts, lockout circuit 16 prevents switching device 20 from coupling reserve power source 18 with connection 24 even if power controller 13 attempts to couple source 18 with connection 24 using switching device 20). Alternatively, lockout circuit 13 may compare voltage of rectifier 30 to a threshold voltage to determine lockout operations.

Switching device 20 may be subjected to excessive currents if the voltage magnitude of rectifier 30 is less than the voltage magnitude of reserve power source 18 (or below a predetermined threshold) wherein upon closure of switching device 20 excessive current may be provided into rectifier 30.

In addition, if a polarity of rectifier 30 of main power source 22 is improperly installed (e.g. reversed) with respect to connection 24, lockout circuit 16 controls switching device 20 to prevent coupling of reserve power source 18 and connection 24 despite power control signals from power controller 13 instructing switching device 20 to couple source 18 and connection 24. Capacitance present in rectifier 30 may operate as a short circuit to reserve power source 18 if the polarity is incorrect therebetween. Such short circuit currents may damage switching device 20.

According to additional aspects, lockout circuit 16 is operable to monitor reserve power source 18 and control switching device 20 responsive to such monitoring. For example, lockout circuit 16 monitors a polarity of reserve power source 18 with respect to connection 24. If lockout circuit 16 determines the polarity of reserve power source 18 is reversed with respect to connection 24, lockout circuit 16 prevents coupling of reserve power source 18 with connection 24 via switching device 20 despite the presence (or absence) of a power control signal from power controller 13 wishing to couple reserve power source 18 and connection 24 using device 20.

Monitoring of reserve power source 18 and disabling closure of switching device 20 responsive to the monitoring protects reserve power source 18 from supplying short circuit current in a reverse polarity situation to capacitive or other devices of rectifier 30 as described previously.

The illustrated embodiment of FIG. 2 also prevents damage to contacts of switching device 20 in the presence of a short circuited load 12 coupled with connection 24. A short circuit within a load 12 could result in excessive currents through switching device 20 once reserve power source 18 is brought on-line and coupled with connection 24 using device 20.

More specifically, and in accordance with aspects of the present invention, with reserve power source 18 arranged correctly with respect to polarity but with rectifier 30 of main power source 22 in an off condition, switching device 20 is locked out by lockout circuit 16 and no damage occurs as described previously despite the presence of a short circuited load 12. If the rectifier 30 is powered and connected to load 12, switching device 32 configured as a circuit breaker receives the short circuit currents which triggers opening of switching device 32 to protect rectifier 30 and other system components. Accordingly, the telecommunications power distribution system 10 of the present invention including lockout circuit 16 also protects main power source 22, reserve power source 18, switching device 20 and other components in a shorted load condition.

According to one embodiment of the present invention, once switching device 20 is closed to couple reserve power source 18 and connection 24, lockout circuit 16 is disengaged from further controlling operation of switching device 20 until switching device 20 is again opened at a subsequent moment in time responsive to control from power controller 13, or for other reasons. Switching device 20 is most vulnerable to damage during installation or powering up of components of system 10. Accordingly, following such subsequent opening of switching device 20, lockout circuit 16 is again engaged and operative to protect components from potential overage conditions and damage.

An indicator 14 is coupled with switching device 20 and is operable to indicate the status of switching device 20. Such indicates switching device 20 being in an open condition or closed condition. Indicator 14 may be located locally on site and/or in a remote monitoring facility, control station or other appropriate facility. An exemplary embodiment of indicator 14 is shown in FIG. 6.

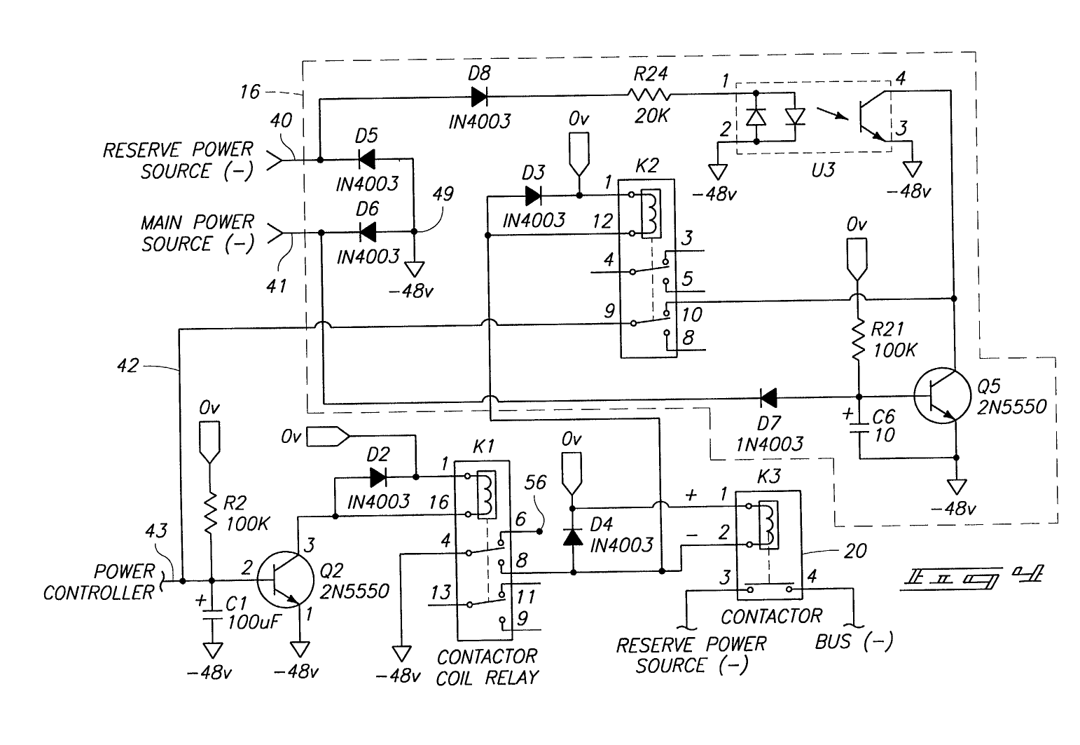

According to additional aspects of the invention, telecommunications devices 28 are often installed in a bay of equipment. Lockout circuit 16 is configured to be removable (e.g., hot swapable) from system 10 for replacement or other reasons. If lockout circuit 16 is removed, circuitry (illustrated as resistor R2 in FIG. 4 according to one exemplary configuration) is provided to maintain the switching device in a closed state if the switching device was closed when lockout circuit 16 was removed. Further, the circuitry including R2 of FIG. 4 operates to close switching device 20 if device 20 is in an open state when lockout circuit 16 is removed. Such operations allow reserve power source 18 to supply power to connection 24 without the protections afforded by lockout circuit 16. Once lockout circuit 16 is replaced, the protection functionality thereof resumes.

According to additional aspects of the invention, power controller 13 is configured to monitor voltages of reserve power source 18 and main power source 22. Power controller 13 is configured to selectively open switching device 20 (assuming device 20 is currently closed) responsive to the monitoring. For example, if the voltages of reserve power source 18 and main power source 22 drop below a threshold voltage, power controller 13 is configured to open switching device 20.

In the presently described exemplary embodiment, power controller 13 is configured to open switching device 20 responsive to voltages (magnitude) of reserve power source 18 and main power source 22 individually dropping below a first threshold, such as −42 Volts. Thereafter, power controller 13 is configured to attempt to close switching device 20 once the voltage (magnitude) of reserve power source 18 or main power source 22 exceeds a second threshold, such as −49 Volts. Switching device 20 is then closed responsive to control from power controller 13 if permitted by lockout circuit 16 as described above.

Referring to FIG. 4, an exemplary embodiment of lockout circuit 16 and associated circuitry are depicted with respect to switching device 20. In the depicted embodiment of FIG. 4, switching device 20 is implemented as a contactor as shown. Other hardware components and/or arrangements of lockout circuit 16 are possible. In addition, lockout circuit 16 may be implemented in software in other arrangements.

As described previously, lockout circuit 16 is configured according to aspects of the present invention to sense whether or not rectifier 30 is powered up by comparing a voltage from main power source 22 with a voltage of reserve power source 18 or, alternatively, a threshold voltage. In the described configuration, if the voltage of main power source 22 on coupling 41 is approximately 1.4 Volts less than a voltage of reserve power source 18 on line 40, transistor Q5 turns on holding a base of transistor Q2 low which provides a contactor coil relay K1 in an “off” state and switching device 20 comprising a contactor K3 is de-energized preventing possible damage to switching device 20.

If switching device 20 comprising the contactor is engaged, relay K2 is energized and prevents the lockout circuit 16 from operating by opening coupling 42. Capacitor C6 coupled with transistor Q5 is implemented to provide a short delay before lockout circuit 16 operates to prevent chatter within switching device 20 if the lockout circuitry 16 is hot swapped with respect to the power controller 13 and switching device 20.

As previously mentioned, lockout circuit 16 is additionally configured to prevent switching device 20 from coupling reserve power source 18 and connection 24 if reserve power source 18 is coupled in a reversed polarity arrangement with respect to connection 24. In such a condition, diode D8 is forward-biased turning opto-coupler U3 on which holds a base of transistor Q2 low. Providing the base of Q2 in a low voltage condition maintains contactor coil relay Q1 in an off condition and keeps switching device 20 in a de-energized state preventing possible damage to switching device 20.

Lockout circuit 16 is additionally arranged to prevent power controller 13 from coupling reserve power source 18 with connection 24 if the polarity of rectifier 30 of main power source 22 is reversed with respect to connection 24. If power is applied to rectifier 30 with the leads thereof reversed with respect to connection 24, diode D7 is reversed-biased preventing damage to transistor Q5. Resistor R21 pulls a base of transistor Q5 high turning on transistor Q5 and holding a base of transistor Q2 low which maintains coil relay K1 off and switching device 20 de-energized preventing possible damage to switching device 20.

As mentioned above, resistor R2 comprises circuitry configured to maintain the switching device in a closed state if the switching device was closed when lockout circuit 16 was removed. In the depicted arrangement, resistor R2 pulls the base of transistor Q2 high if power controller 13 and lockout circuit 16 are removed or hot swapped enabling reserve power source 18 to provide uninterrupted power to connection 24.

As shown in FIG. 4, contact 6 of relay K1 is coupled with the indicator 14 in the depicted arrangement. Indicator 14 indicates operation of switching device 20 responsive to signals received from relay K1 according to the described embodiment and is described in further detail below in FIG. 6.

Referring to FIG. 5, an exemplary embodiment of power controller 13 is shown. Power controller 13 comprises a comparator circuit 50 operable to monitor the voltages of reserve power source 18 and main power source 22 via node 49 of FIG. 4. Comparator circuit 50 has a designation MAX8211 available from Maxim Integrated Products, Inc. in the illustrated embodiment.

Responsive to a voltage magnitude of either source 18, 22 being greater than a threshold (e.g., −42 Volts), comparator 50 asserts a logical high signal upon node 43 applied to circuitry in FIG. 4 to close switching device 20 if permitted by lockout circuit 16. Alternatively, comparator 50 asserts a logical low signal upon node 43 if both voltage magnitudes of sources 18, 22 drop below the threshold. Application of the logical low signal to node 43 opens switching device 20. Other configurations of power controller 13 are possible.

Referring to FIG. 6, an exemplary indicator 14 is shown. Indicator 52 comprises a light emitting diode 52 configured to indicate status of switching device 20. The base of transistor 54 is coupled with pin 6 of relay K1 of FIG. 4 via node 56 in the described embodiment. Responsive to relay K1 of FIG. 4 being energized (corresponding to switching device 20 being closed), node 56 floats and the base of transistor 54 is pulled high providing diode 54 in an Off state. Responsive to relay K1 of FIG. 4 being de-energized (corresponding to switching device 20 being open), node 56 is coupled with the ground reference and the base of transistor 54 is low providing diode 54 in an On state. Other configurations of indicator 14 are possible.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

1. A telecommunications power distribution system comprising:
a main power source;
a reserve power source;
a telecommunications device connection adapted to supply power to at least one telecommunications device configured to perform at least one operation with respect to telecommunications;
a switching device configured to selectively couple the reserve power source device with the telecommunications device connection; and
a lockout circuit configured to monitor an electrical condition of at least one of the main power source and the reserve power source, and to control the switching device responsive to the monitoring.

2. The system of claim 1 wherein the lockout circuit is configured to monitor the electrical condition comprising a voltage of the main power source.

3. The system of claim 1 wherein the lockout circuit is configured to control the switching device to prevent coupling of the reserve power source and the connection responsive to a voltage of the main power source being below a threshold.

4. The system of claim 1 wherein the lockout circuit is configured to control the switching device to prevent coupling of the reserve power source and the connection responsive to a comparison of respective voltages of the main power source and the reserve power source with a threshold.

5. The system of claim 1 wherein the lockout circuit is configured to control the switching device to prevent coupling of the reserve power source and the connection responsive to a voltage of the main power source and a voltage of the reserve power source being less than a threshold.

6. The system of claim 1 wherein the lockout circuit is configured to control the switching device to prevent coupling of the reserve power source and the connection responsive to a polarity of the reserve power source being reversed with respect to the connection.

7. The system of claim 1 wherein the lockout circuit is configured to control the switching device to prevent coupling of the reserve power source and the connection responsive to a polarity of the main power source being reversed with respect to the connection.

8. The system of claim 1 wherein the lockout circuit is configured to control the switching device to prevent coupling of the reserve power source and the connection responsive to a load coupled with the connection being in a shorted condition.

9. The system of claim 1 further comprising a power controller configured to provide a power control signal to control the switching device, and wherein the lockout circuit is configured to selectively prevent the power control signal from controlling the switching device responsive to the monitoring.

10. The system of claim 1 wherein the lockout circuit is removable, and further comprising circuitry configured to provide the switching device in a closed state if the lockout circuit is removed.

11. The system of claim 1 wherein the lockout circuit is disengaged from controlling the switching device after controlling the switching device to couple the reserve power source and the connection.

12. The system of claim 11 further comprising a power controller configured to monitor a voltage of the main power source and to open the switching device with the lockout circuit disengaged and responsive to the monitoring of the voltage using the power controller.

13. The system of claim 1 further comprising an indicator coupled with the lockout circuit to indicate operation of the switching device.

14. A telecommunications power distribution system comprising:
a reserve power source;
a telecommunications device connection adapted to supply power to at least one telecommunications device configured to perform at least one operation with respect to telecommunications;
a switching device configured to selectively couple the reserve power source device with the telecommunications device connection;
a power controller configured to selectively provide a power control signal to control the switching device to couple the reserve power source with the telecommunications device connection; and
a lockout circuit configured to selectively prevent the power control signal from controlling the switching device responsive to an operational condition of the telecommunications power distribution system.

15. The system of claim 14 further comprising a main power source configured to supply power to the connection, and wherein the lockout circuit is configured to selectively prevent the power control signal from controlling the switching device responsive to the operational condition comprising a voltage of the main power source being below a threshold.

16. The system of claim 14 further comprising a main power source configured to supply power to the connection, and wherein the lockout circuit is configured to selectively prevent the power control signal from controlling the switching device responsive to the operational condition comprising a comparison of respective voltages of the main power source and the reserve power source with a threshold.

17. The system of claim 14 further comprising a main power source configured to supply power to the connection, and wherein the lockout circuit is configured to selectively prevent the power control signal from controlling the switching device responsive to the operational condition comprising a voltage of the main power source and a voltage of the reserve power source being less than a threshold.

18. The system of claim 14 further comprising a main power source comprising configured to supply power to the connection, and wherein the lockout circuit is configured to selectively prevent the power control signal from controlling the switching device responsive to the operational condition comprising a polarity of the main power source being reversed with respect to the connection.

19. The system of claim 14 wherein the lockout circuit is configured to selectively prevent the power control signal from controlling the switching device responsive to the operational condition comprising a polarity of the reserve power source being reversed with respect to the connection.

20. A telecommunications power distribution circuit comprising:
a first coupling adapted to couple with a main power source;
a second coupling adapted to couple with a reserve power source;
a third coupling adapted to communicate a control signal to control selective coupling of the reserve power source device with a telecommunications device connection configured to supply power to at least one telecommunications device configured to perform at least one operation with respect to telecommunications; and
a lockout circuit configured to receive signals from at least one of the first coupling and the second coupling to monitor an electrical condition of at least one of the main power source and the reserve power source, the lockout circuit being further configured to provide the control signal to the third coupling responsive to the monitoring.

21. The circuit of claim 20 wherein the lockout circuit is configured to monitor the electrical condition comprising a voltage of the main power source.

22. The circuit of claim 20 wherein the lockout circuit is configured to monitor the electrical condition comprising a voltage of the main power source and to provide the control signal to prevent coupling of the reserve power source and the connection responsive to the voltage of the main power source being below a threshold.

23. The circuit of claim 20 wherein the lockout circuit is configured to monitor the electrical condition comprising a voltage of the main power source and a voltage of the reserve power source and to provide the control signal to prevent coupling of the reserve power source and the connection responsive to a comparison of respective voltages of the main power source and the reserve power source with a threshold.

24. The circuit of claim 20 wherein the lockout circuit is configured to monitor the electrical condition comprising a voltage of the main power source and a voltage of the reserve power source and to provide the control signal to prevent coupling of the reserve power source and the connection responsive to a voltage of the main power source and a voltage of the reserve power source being less than a threshold.

25. The circuit of claim 20 wherein the lockout circuit is configured to monitor the electrical condition comprising a polarity of the main power source and to provide the control signal to prevent coupling of the reserve power source and the connection responsive to a polarity of the main power source being reversed with respect to the connection.

26. The circuit of claim 20 wherein the lockout circuit is configured monitor the electrical condition comprising a polarity of the reserve power source and to provide the control signal to prevent coupling of the reserve power source and the connection responsive to a polarity of the reserve power source being reversed with respect to the connection.

27. The circuit of claim 20 wherein the lockout circuit is configured to provide the control signal to prevent coupling of the reserve power source and the connection responsive to a load coupled with connection being in a shorted condition.

28. The circuit of claim 20 further comprising a fourth coupling adapted to couple with a power controller configured to provide a power control signal to control coupling of the reserve power source and the connection, and wherein the lockout circuit is configured to provide the control signal to selectively prevent the power control signal from controlling the coupling of the reserve power source and the connection.

29. The circuit of claim 20 wherein the lockout circuit comprises a removable component, and further comprising circuitry configured to provide the switching device in a closed state if the lockout circuit is removed.

30. The circuit of claim 20 wherein the lockout circuit is configured to disengage from the third coupling after providing the control signal to enable coupling of the reserve power source and the connection.

31. The circuit of claim 20 further comprising a switching device configured to selectively couple the reserve power source and the connection, and the third coupling provides the control signal to the switching device.

32. The circuit of claim 31 further comprising an indicator coupled with the lockout circuit to indicate operation of the switching device.

33. A method of supplying power to at least one telecommunications device configured to perform at least one operation with respect to telecommunications, the method comprising:
monitoring at least one electrical condition of a main power source and a reserve power source;
electrically coupling the reserve power source and a telecommunications device connection adapted to supply power to at least one telecommunications device; and
controlling the coupling responsive to the monitoring of the at least one electrical condition of the main power source and the reserve power source to selectively control application of power from the reserve power source to the telecommunications device coupled with the telecommunications device connection.

34. The method of claim 33 wherein the monitoring comprises monitoring the at least one electrical condition comprising a voltage of the main power source.

35. The method of claim 33 wherein the controlling comprises controlling to prevent coupling of the reserve power source and the connection responsive to a voltage of the main power source being below a threshold.

36. The method of claim 33 wherein the controlling comprises controlling to prevent coupling of the reserve power source and the connection responsive to a comparison of respective voltages of the main power source and the reserve power source with a threshold.

37. The method of claim 33 wherein the controlling comprises controlling to prevent coupling of the reserve power source and the connection responsive to a voltage of the main power source and a voltage of the reserve power source being less than a threshold.

38. The method of claim 33 wherein the monitoring comprises monitoring a polarity of the main power source and the controlling comprises controlling to prevent coupling of the reserve power source and the connection responsive to the polarity of the main power source being reversed with respect to the connection.

39. The method of claim 33 wherein the monitoring comprises monitoring a polarity of the reserve power source and the controlling comprises controlling to prevent coupling of the reserve power source and the connection responsive to the polarity of the reserve power source being reversed with respect to the connection.

40. The method of claim 33 wherein the controlling comprises controlling to prevent coupling of the reserve power source and the connection responsive to a load coupled with the telecommunications device connection being shorted.

41. The method of claim 33 further comprising generating a power control signal to control a switching device intermediate the reserve power source and the telecommunications device connection, and wherein the controlling comprises selectively preventing the control signal from controlling the switching device.

42. The method of claim 33 wherein the controlling comprises controlling using a lockout circuit, and further comprising disengaging the lockout circuit responsive to coupling of the reserve power source and the connection.

43. The method of claim 42 wherein the coupling comprises coupling using a switching device intermediate the reserve power source and the telecommunications device connection, and further comprising monitoring a voltage of the main power source using a power controller, and controlling opening of the switching device using the power controller responsive to the monitoring of the voltage of the main power source.

44. The method of claim 33 wherein the coupling comprises coupling using a switching device intermediate the reserve power source and the telecommunications device connection, and further comprising indicating operation of the switching device.
